(19) United States
(12) Patent Application Publication
(10) Pub. No.: US 2017/0303552 A1
(43) Pub. Date: Oct. 26, 2017

(54) Polyethylene glycol-lactide coating on fresh eggs

(71) Applicants: Ozan Gurbuz, Winter Haven, FL (US); Gulsen Goncagul, Bursa (TR); Yasemin Sahan, Bursa (TR); Ali Kara, Bursa (TR)

(72) Inventors: Ozan Gurbuz, Winter Haven, FL (US); Gulsen Goncagul, Bursa (TR); Yasemin Sahan, Bursa (TR); Ali Kara, Bursa (TR)

(21) Appl. No.: 14/999,301

(22) Filed: Apr. 21, 2016

(51) Int. Cl. A23B 5/06; A01N 37/36; C09D 5/14; C09D 167/04

(52) U.S. Cl. CPC A23B 5/06; C09D 167/04; A01N 37/36; C09D 5/14; A23V 2002/00

(57) ABSTRACT

A process for coating fresh eggs with a coating composition including coating the eggs with a polyethylene glycol-lactide aqueous dispersion, the process being useful for: reducing microbial content both within and outside the fresh eggs, preventing further contamination of the fresh eggs, extending the shelf life of the fresh eggs, maintaining the quality of the fresh eggs, and increasing the strength of the shells of the fresh eggs.

This application is a Continuation in Part application Ser. No. 14/999,301, filing date of Apr. 21, 2016. There is no new matter in this specification.

### BACKGROUND OF THE INVENTION

The present invention relates to food origins of infection in humans and among those origins of infections are mainly Salmonella Enteritidis and Escherichia coli. In recent years, Salmonella infections have been increasingly observed in human studies. All of the infections described, regarding eggs in the shell, are due to pathogenic bacteria and microorganisms. Current practices today, remove microorganisms primarily from the exterior of the egg shell with pasteurization, chemical or mechanical methods.

Pasteurization is employed to kill the major part of all the vegetative form or pathogenic microorganisms in the egg and provide the eggs or egg products with extended shelf life. Pasteurization is a thermal process of at least 30 minutes at 63° C. or 15 seconds at 72° C. or temperatures below 100° C. for an appropriate time or a combination of the two factors.

This method aims to neutralize the pathogenic microorganisms by disturbing the protein structure through heat. However, the same thermal effect used on the microorganisms also impacts the eggs due to destruction of protein structure. The thermal process does not discriminate between the microorganism protein and the egg protein. This heat treatment applied to the egg means the nutritive qualities of the egg are reduced. Pasteurized eggs are not intended for fresh consumption and are partially cooked. More detailed examination of the pasteurization process in the shell indicates the impact is only during the pasteurization and in the later stages (storage, transport, etc.) does not provide a protection against possible additional microbial contamination. Kramer et al. ((US 2007/0141214 A1) uses a dipping method to coat eggs and dries them in a 40° C. air current which also has the potential to disturb the egg protein.

Chemical methods employ, although allowed legally in the Food Codex, the use of chemicals to destroy pathogenic microorganisms located on the eggs. It is accomplished by poisoning. These chemicals destroy harmful microorganisms on egg shells, however, they leave residue and can penetrate to the contents of the egg, with the potential of affecting human health adversely.

There are also various coatings which are utilized to increase preservation by reducing the possibility of infectious microorganisms penetrating an egg from the exterior as in Ukai et al. (U.S. Pat. No. 3,997,674) who uses an immersion solution and Kramer et al. (US 2007/0141214 A1). Lahav et al. (U.S. Pat. No. 7,708,822) presents a formulation of an aqueous dispersion for coating fowl eggs where, after dispersing a coating comprised of natural biological sources, the eggs were stored at 6° C. Although Katchalsky et al. (U.S. Pat. No. 3,420,790) does utilize polyethylene as one ingredient in a coating for fruits and vegetables, also included in the emulsion are a natural wax, a saponifiable emulsifying agent and a stabilizing agent

Liu et al. (U.S. Pat. No. 0,232,662) provides a coating which includes polyethylene glycol but also includes a cross-linkable polymer and the coating is designed to be on a product used orally. Miyamoto et al. (JP 2000136346 A) also utilizes polyethylene glycol, d-Lactide, and L-lactide however the ratios between the three compounds are dissimilar, the preparation of the copolymer involved an aluminum catalyst, and the coating material is not to be utilized with food products.

Mechanical methods are methods which include an initial spray washing, disinfecting and finally cooling. During the washing, the natural film of the eggshell cuticle, is washed off. The cuticle has not been proven to be a strong barrier to bacteria. However, there have been studies in which it was found that refrigerated storage (4° C.) was necessary to reduce bacteria growth and penetration into the egg.

Unlike other chemicals methods used, which have toxic effects, polyethylene glycol is a flexible, water-soluble polymer that is non-toxic, odorless, neutral, nonvolatile, and non-irritating. It has no negative effect on human health.

Polyethylene glycol film bath is used today in many technical fields for a variety of applications: Pharmaceuticals and medications as a solvent, to make emulsifying agents; in detergents and as plasticizers, humectants, and dyeing in the textiles industry; in ointment and suppository bases; and in photography. It has not been used in the egg industry.

### BRIEF SUMMARY OF THE INVENTION

Although eggs are a very nutritious food, storage conditions, as well as the microorganisms found within an egg load can spoil the egg very quickly. In fact, some microorganisms have been shown to contribute to human food poisoning. The transmission of microorganisms into the egg can take place via transovarian (where the existing microorganisms inside a chick ovarium, during the laying, pass directly into the egg). Infection is not desirable to maintain egg quality.

Our invention involves fresh egg surface coated with an aqueous polyethylene glycol polylactic acid film so it does not create risk of degradation of the egg protein structure. For that reason, any loss of nutritional value by protein decomposition is not of concern.

The difficulties of other processes previous mentioned are overcome with our process by the inhibition of harmful microorganisms' growth within the egg shell. Our process actively prevents their proliferation inside the shell while creating a protective layer which also prevents moisture loss and creates a positive effect on the shelf life of shell eggs. Polyethylene glycol-lactide, as a film layer on the egg shell, closes pores and prevents microorganisms from entering into the eggs.

This invention is intended to inhibit the microbial content within fresh eggs. The coating also provides protection against possible contamination during storage time, transportation, and marketing of the eggs. The film layer makes the shell egg more resistant to external shocks through the handling and packaging stages therefore largely precludes broken egg shells.

Results also demonstrate that the egg weight exhibited less of a decrease compared with control (non-coated) eggs during the storage period studied. It is a coating which is already widely used today in the fresh food packaging industry. Therefore, a coating left on the exterior of an egg shell doesn't represent a problem nor it is visually apparent to customers.

Polyethylene glycol film bath is used today in many technical fields for a variety of applications: Pharmaceuticals and medications as a solvent, to make emulsifying agents; in detergents and as plasticizers, humectants, and dyeing in the textiles industry; in ointment and suppository bases; and in photography. It has not been used in the egg industry.

Our process is the use of a polyethylene glycol-lactide aqueous solution to coat a fresh egg surface. The copolymer has an organic structure and no negative effect on human health such as the toxic effects found with other chemicals. The copolymer has the capacity to negatively influence microorganisms. The coating is already widely used today in the fresh food packaging industry.

### BRIEF DESCRIPTION OF DRAWINGS

FIG. 1 is a sample of the microstructures of eggshell surface coated with 10% PEG-Lactide mounted in a scanning electron microscopy (Carl Zeiss EVO 40) to visualize the surface structure of each egg-shell surface sample at desired magnification levels (FIGS. 3-10). SEM was operated on high vacuum mode, WD: 34.5 mm and magnification: 1.00 KX.

FIG. 2 is a SEM micrograph of the microstructures of eggshell surface of the Control (non-coated egg) mounted in a scanning electron microscopy (Carl Zeiss EVO 40) to visualize the surface structure of each egg-shell surface sample at desired magnification levels (FIGS. 3-10). SEM was operated on high vacuum mode, WD: 34.5 mm and magnification: 1.00 KX.

### DETAILED DESCRIPTION OF THE INVENTION

Water soluble polyethylene glycol (molecular weight of 400 kDa, CAS Number 25322-68-3; density, 1.128 g/mL; melting point, 408° C.; LD50 30 mL/kg) was purchased from Sigma-Aldrich (Chemie Gmbh, Munich, Germany). Polyethylene glycol-lactide molecular weight of 30,000 (5,000-100,000) kDa; density 1400 (1100-1700) kg/m³, melting point, 145° C. (130-180) was synthesized according to the following procedure. Polymer synthesis was achieved with chain-opening polymerization catalyzing with Sn(II)-ethyl hexanoate. 1 mole polyethylene glycol and 2 moles of DL-lactic acid were inserted into a 250 mL glass balloon and SN(II)0ethyl hexanoate added. The solution in the glass balloon was then stirred for 24 hours at 300 rpm in a 180° C. oil bath with a reflux cooler. At the end of the 24 hours, the solution containing the ethyl alcohol-ether polymer was dissolved in diclormethane and cooled down to 25° C. with petroleum ether. The purified polyethylene glycol polylactic acid (PEG-PLA) polymer was vacuum dried at 70° C. and stored in a vacuum desiccator according to the process described by Riley et al. in the journal entitled Langmuir (2001). 10% concentration of polyethylene glycol-lactide, with the final pH of 4.7 was prepared by dissolving polyethylene glycol-lactide in distilled water 2 mL/100 mL (V/V) concentration. Experiments were performed with an aqueous solution of polyethylene glycol-lactide, in a concentration of 10%.

Seventeen different microorganisms were used: 7 bacteria strains, 10 fungi (4 yeasts and 6 molds). They included: Bacteria; Bacillus cereus ATCC 6464, Escherichia coli ATCC 25922, Salmonella Enteritidis ATCC 13076, Staphylococcus aureus ATCC 6538, Klebsiella pneumonia ATCC 700603, Enterobacter ATCC 19434; Yeasts; Yercinia enterocolitica ATCC 29913, Saccharomyces cerevisiae DSMZ 2548, Metschnikowis fructicola CBS 8853, Candida albicans ATCC 10231, Candida oleophila ATCC 28137; and Molds; Aspergillus niger ATCC 16604, Aspergillus parasiticus ATCC 22789, Aspergillus oryzae ATCC 11499, Rhizopus oryzae ATCC 24536, Fusarium oxysporum ATCC 7602, Penicillium expansum ATCC 16104.

To prepare the microbial culture which was to be injected into the egg, Nutrient Broth (NB-Oxoid CM0501) and Nutrient Agar (NA-Ocoid CM03009) was used for the bacterial growth medium. Sabouraud Dekstroz Broth (SDB Difco 23400) and Sabouraud Dekstroz Agar (SDA Difco 212000) were used as the mold and yeast growth mediums. Microbial strains, EMB agar (Eosin Methylenblau Lactose Saccharose Merck 101347) and Blood agar (Merck 110886) from stock cultures and incubated 24 h at 37° C. and 20° C., a process described by Chung et al. in the journal, Pharmaceutical Biology (2004). Spore suspension was used for the 24 hour mold culture.

Experiments were performed five times for each isolate. Fungi were cultured on Sabouraud Dextrose Agar (Difco, Detroit, Mich.) plates at 30° C. for 7 days. 1 mL spore suspension was inserted into 59 mL of Sabouraud Dekstroz broth medium. Ten mL of sterile Tween 80 (1%) was added for spore collection to allow the mold spores to pass through into solution. Conidia were harvested by centrifugation (Hettich, Eba 3S, Germany) at 1,000 rpm for 15 min and washed with 10 mL of sterile distilled water. This step was repeated three times and the spore suspension was stored in sterile distilled water (30 mL) at 4° C. until used. The concentration of spores in the suspension was determined by a viable spore count on Sabouraud Dextrose Agar plates using the spread plate, surface count technique described by Yin and Tsao in the journal, International Journal of Food Microbiology (1999) and Lopez-Malo et al. also in the journal, International Journal of Food Microbiology (2005). After incubation the young cultures were used for microbial growth analysis.

Rapid identification and quantitative determination of antimicrobial susceptibility by determination of minimal inhibitor concentration (MIC) was utilized with a tube-dilution method described by Chandraskaran and Venkatesalu in the Journal of Ethnopharmacology (2004), Mathabe et al. also in the Journal of Ethnopharmacology (2006), and Fazeli et al. in the journal entitled Food Control (2007). The inhibition effect from the polymer concentration was measured. PEG-lactide concentrations were applied frequently instead of the method which is in the previously reported literature. For this reason, microbial inhibition effect was observed in every dose. 4 mL of the serial dilutions were inserted in NB (for bacterial growth) and SDB (for yeast and mold growth) mediums. The maximum dose was 100 mg/mL. Next, 1 mL portions of the concentration was added to test tubes containing 4 mL of special medium. Microbial inoculation level for each dilution tube was 50 μL (bacterial cell account, 10⁶ and yeast and mold account 10⁴) which was prepared from 24 h broth cultures and added to the tubes that contained the PEG-lactide concentration and appropriate medium. Test tubes were incubated at 30° C. for 72 hours. The lowest concentration in which there was no visible turbidity defined the MIC concentration.

Using the results of the MIC assay, the concentrations showing complete absence of visual growth of microorganisms were identified and 100 μL of each culture broth was transferred and spread on NA (for bacteria) and SDA (molds and yeasts) for colony counting. The plates were incubated at 37° C. for 48 h for bacteria, 30° C. 48 h for yeasts and 30° C. 72-96 h for fungi. The complete absence of growth on the agar surface sample was defined as minimal bactericidal concentration (MBC) as described by Dung et al. in the journal entitled Food and Chemical Toxicology (2008), Korulduoglu et al. in the Journal of Food Safety (2009), and Devi et al. in the Journal of Ethnopharmacology (2010).

Table 1 refers to the results and they were recorded in terms of MIC (mg/mL) percent activity values which demonstrated the total antimicrobial potcncy of the polymer concentration as described by Rangasamy et al. in the Journal of Ethnopharmacology (2007).

$$Activity ( \% ) = 100 \times \frac{no . of susceptible stains to a concentration}{total no . of tested microorganisms}$$

TABLE 1
Antimicrobial characterization of PEG-polylactide
(10%) on tested microorganisms (mg/mL).

| MICROORGANISMS | MIC | MBC/MFC |
|---|---|---|
| Bacillus cereus ATCC 6464 | 25 | 50 |
| Escherichia coli ATCC 25922 | 37.5 | 50 |
| Salmonella Enteritidis ATCC 13076 | 50 | 75 |
| Staphylococcus aureus ATCC 6538 | 50 | 100 |
| Klebsiella pneumonia ATCC 700603 | 50 | 75 |
| Enterobacter ATCC 19434 | 75 | 100 |
| Yersinia enterocolitica ATCC 29913 | 25 | 100 |
| Candida albicans ATCC 10231 | 100 | 100 |
| Aspergillus parasiticus ATCC 22789 | 100 | 100 |
| Penicillium expansum ATCC 16104 | 50 | 100 |

MIC: Minimum Inhibitory Concentration
MFC: Minimum Fungicidal Concentration
MBC: Minimum Bactericidal Concentration

Bacteria showed more sensitivity to the PEG-lactide than the fungi microorganisms used. Enterobacter ATCC 19434 was found to be the most resistant bacteria and S. aureus followed. The bacteria most sensitive to PEG-lactide was Bacillus cereus followed by E. coli. Molds and yeasts were found to be more resistant than bacteria against the PEG-lactide. MIC and MFC could not be determined on the fungi tested at the concentrations used with the exception of the yeast C. albicans, and the molds P. expansum and A. parasiticus. However, fungi were affected in the form of a log decimal reduction.

1,240 Specific Pathogen Free eggs from 52 weeks old hens were purchased. Specific Pathogen Free eggs were used to ensure that the eggs did not contain microbial content prior to injection. Upon arrival from the farm, the eggs were screened with Sartorius (BP 221S, Goettingen, Germany) for defects (cracks, breakage and surface cleanliness) as well as a desirable weight range (60±0.2). Eggs outside of the preferred range were excluded to reduce variation.

All eggs were stored in a cold room (4° C.) after arrival. The following day eggs were kept at room temperature for 5 hours to avoid water condensation on the egg surface that could interfere with coating. The eggs were divided into 2 groups, one group for the polyethylene glycol lactide concentration and one control group.

To prepare the eggs for inoculation, air pockets within the eggs were located and eggs were placed, with the air pocket on top, into the egg racks (viol). The air pocket was drawn with pencil on the exterior of the shell and a code identifying the polymer and concentration was written on the egg. Also the inoculation point was marked. This part of the process took place in a sterile cabinet (Laminar-air). In addition to the sterile cabinet location, the inoculation point on the egg was disinfected using a cotton swab with 70% ethanol. A hole was opened at the identified inoculation point with a sterile piercing instrument. Inoculum fluid was withdrawn into a sterile syringe and 1 mL inoculation liquid (1×10 through 8 CFU/mL) injected into the egg yolk at a 90-degree slope. The opened holes were closed with paraffin tape. Only fresh, single-use materials (syringes, cotton, etc.) were used, put into red biological waste bags, and burned after use.

The coating material was applied to the entire surface of each egg with a manual spray gun E/70 (φ 1.5 mm nozzle) (Direct Industry Technolab GmbH, Germany) for 3 minutes, and left to dry on racks in the horizontal position at room temperature. Upon drying, the coated eggs were placed small end down on viols, similar to that reported by Kim et al. in the journal entitled, International Journal of Food Science and Technology (2009) and stored in an incubator set at 37° C. Quality measurements were made following days (1, 7^{th}, 14^{th}, 30^{th}, 45^{th} and 60^{th} day). PEG-lactide coated egg groups consisted of 10% concentration PEG-lactide. The control group was inoculated but did not receive any coating.

On the final day of this study, the weight of the egg (g) was measured with Sartorius BP 221S (Goettingen, Germany); eggshell thicknesses were measured from three different places, the top, middle and the bottom of the egg shell (μ) with an Egg Thickness Gauge (Orka Technology Co., Israel) along with couplant ultrasound gel (Soundsafe, SINOTECH Industrial Ultrasonic). The three measurements of the eggshell were averaged. The average eggshell thickness of a non-coated egg (control) was 0.406±0.010 and of a fresh egg coated with the polyethylene glycol-lactide 0.430±0.015. Their respective egg weight averages after 60 days of storage were non-coated eggs 60.33±1.011, and the coated eggs 61.96±1.902.

After the measurements of eggshell thickness and egg weight were taken on all individual eggs, the breaking strength of uncracked eggs was measured with an IMADA PS Model Number: SV-05 testing machine (IMADA Co. Japan) and was recorded in maximum force (50N/cm²) required to crack the shell surface. The egg shell breaking strength of uncoated eggs was 29.12±8.212 while the coated eggs recorded a strength of 42.16±3.426.

Haugh unit, yolk color (1 to 15 according to Roche Yolk color fan), albumen height and ranks were measured using an egg analyzer (Orka Food Technology Ltd, Israel).

Film thicknesses were measured with a digital micrometer (Mitutoyo, Japan, ZETT MESS KMG type—AMG 18/15) to the nearest 0.005 mm. METROLOG XG8 software was used as the measuring program. The process of measuring was accomplished at 20±2° C. and in 50±15% relative humidity. Measurements were taken at seven different random locations on the eggshells and average measurements recorded for eggshell and polymer coating thickness (mm).

The surface structures of the egg-shell were visually eyed and also examined with a scanning electron microscopy (SEM). The egg-shell samples were initially dried in air at 25° C. for 7 days; tiny fragments of the egg-shell surface samples were mounted on SEM sample holders on which they were sputter-coated for 2 min. The samples were then consecutively mounted in a scanning electron microscopy (Carl Zeiss EVP 40) to visualize the surface structure of each egg-shell surface sample at desired magnification. SEM was operated on high vacuum mode, WD: 34.5 mm and magnification: 1.00 KX.

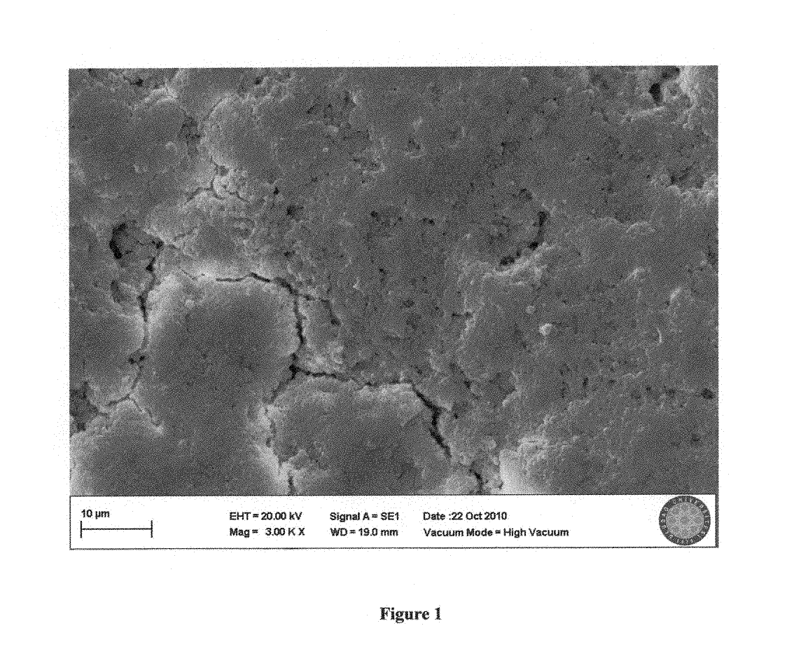

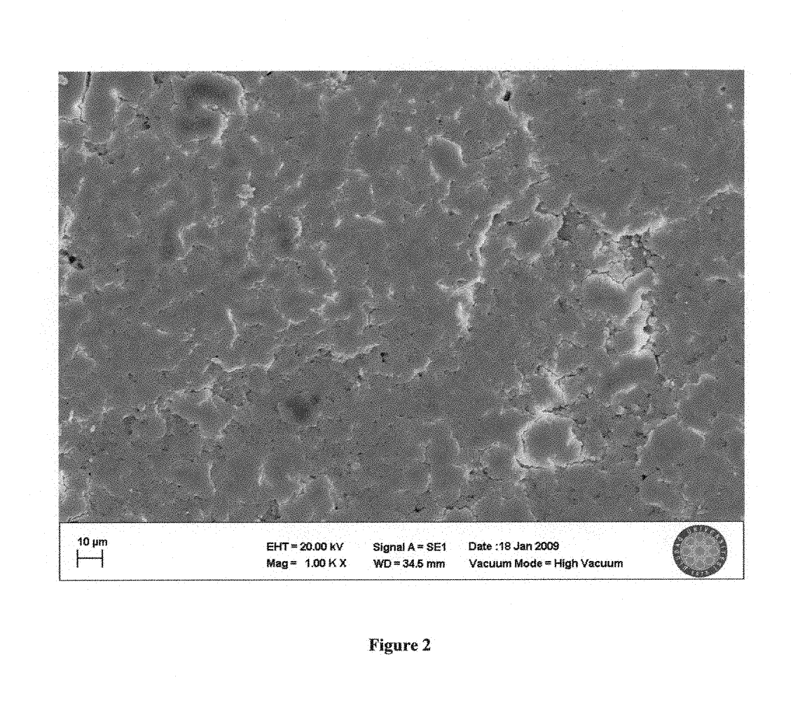

FIGS. 1 and 2 illustrate the difference between a coated and non-coated egg as seen through a scanning electron microscope.

Over the 60 days, the microbial growth count gave evidence of a reduction of food poisoning microorganisms inside the PEG-lactide coated eggs. Also, PEG-lactide at the 10% concentration is a thicker coating and gives a higher egg shell strength rating than uncoated eggs. Coated eggs, opened at the 60th day, were still unspoiled, even at the incubation temperature of 37° C.

While the invention has been described by specific examples and embodiments, there is no intent to limit the inventive concept except as set forth in the following claims.

We claim:

1. A composition of matter comprising: a fresh egg having a shell; and a coating on the shell of the fresh egg, wherein the coating comprises a polyethylene glycol-polylactide copolymer.

2. The composition according to claim 1 wherein the polyethylene glycol-polylactide copolymer has a weight average molecular weight of about 5,000 kDa to about 100,000 kDa.

3. The composition according to claim 1 wherein the polyethylene glycol-polylactide copolymer has a weight average molecular weight of about 30,000 kDa.

4. The composition according to claim 1 wherein the polyethylene glycol-polylactide copolymer has a pH of about 3.7 to about 5.7.

5. The composition according to claim 1 wherein the coating comprises an aqueous solution of polyethylene glycol-polylactide copolymer wherein the ratio of polymer to water is about 2 mL/100 mL (v/v).

6. A process comprising:
obtaining the fresh egg;
providing an aqueous solution of a polyethylene glycol-polylactide copolymer; and
coating the fresh egg with the aqueous solution to obtain a coated egg;
wherein microorganisms within the fresh egg are destroyed; and
wherein protein within the fresh egg is preserved in a natural state.

7. The process according to claim 6 wherein the coating step employs a manual spray gun to coat the fresh egg with the aqueous solution.

8. The process according to claim 6 wherein the coating step is complete in about 2 to about 5 minutes.

9. The process according to claim 6 further comprising drying the coated egg.
